(19) United States
(12) Patent Application Publication
(10) Pub. No.: US 2010/0268441 A1
(43) Pub. Date: Oct. 21, 2010

(54) CONTROLLER FOR FUEL PUMP

(75) Inventor: Naoki YOSHIUME, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/759,085

(22) Filed: Apr. 13, 2010

(30) Foreign Application Priority Data
Apr. 15, 2009 (JP) 2009-98822

(51) Int. Cl. F02D 41/30; F02M 63/00

(52) U.S. Cl. 701/103; 123/447

(57) ABSTRACT

When a starter is started, a start-control duration time is established based on a fuel pressure at engine starting and a target fuel pressure. The start-control duration time corresponds to a duration after the engine is started until a difference between an actual fuel pressure in an accumulator and a target fuel pressure becomes lower than a specified value in a case that the fuel pump discharges the fuel at a maximum rate. A fuel pump discharges the fuel at the maximum rate during the estimated start-control duration time.

### CROSS-REFERENCE TO RELATED APPLICATION

This application is based on Japanese Patent Application No. 2009-98822 filed on Apr. 15, 2009, the disclosure of which is incorporated herein by reference.

### FIELD OF THE INVENTION

The present invention relates to a controller for a fuel pump which is applied to a fuel injection system having an accumulator accumulating high-pressure fuel supplied from the fuel pump and a fuel pressure detecting means for detecting a fuel pressure in the accumulator.

### BACKGROUND OF THE INVENTION

It is known that a controller for a fuel pump is applied to a fuel injection system of a direct injection engine. The fuel injection system includes an accumulator accumulating a high-pressure fuel and a fuel pump supplying the high-pressure fuel to the accumulator. The fuel pump is driven by a pump cam rotating in synchronization with a camshaft of the engine. A discharge rate of the fuel pump is adjusted by controlling an energization of a solenoid installed in the fuel pump. Specifically, a cylinder identification is conducted to determine whether the fuel pump is at a suction stroke or at a discharge stroke. After the cylinder identification, a required discharge rate of the fuel pump is computed based on a proportional term and an integral term of a deviation between an actual fuel pressure and a target fuel pressure so that the actual fuel pressure in the accumulator agrees with the target fuel pressure. Based on this required discharge rate, an energization timing of the solenoid is computed. Thereby, the actual fuel pressure is controlled to agree with the target fuel pressure, which is set at each engine driving condition, and an exhaust characteristic is improved.

When the engine is stopped, the actual fuel pressure in the accumulator gradually decreases. Thus, in a case that the engine has been stopped for a long time period, the actual fuel pressure in the accumulator decreases excessively relative to the target fuel pressure. When the engine is re-started, it is required that the actual fuel pressure is increased to the target fuel pressure immediately. However, since the actual fuel pressure can not be feedback controlled during a period from the engine start until the cylinder identification, an increase in the actual fuel pressure is delayed, so that the exhaust characteristic is deteriorated.

Conventionally, as shown in JP-2008-223528A (US 2008/0216797A1), the solenoid of the fuel pump is continuously energized from the engine start until the completion of the cylinder identification so that the discharge rate of the fuel pump is made maximum, whereby the increase in the actual fuel pressure is expedited and the deterioration in the exhaust characteristic is restricted. A control in which the discharge rate of the fuel pump is made maximum is referred to as a full discharge control, hereinafter. Also, Japanese patent No. 4110065 (US 2005/0045158A1) shows a control method of a solenoid of a fuel pump.

In view of controlling the actual fuel pressure, a completion timing of the cylinder identification is not always appropriate as a completion timing of the fuel discharge control. For example, in a case that the actual fuel pressure is lower than the target fuel pressure at the completion timing of the cylinder identification, the integral term of the feedback control becomes excessively large due to an increase in deviation between the actual fuel pressure and the target fuel pressure. It is likely that an overshoot may occur, in which the actual fuel pressure continues to increase even after the actual fuel pressure reaches the target fuel pressure. In a case that the actual fuel pressure is greater than the target fuel pressure at the completion timing of the cylinder identification, it means that the completion timing of the cylinder identification is late as the completion timing of the full discharge control.

### SUMMARY OF THE INVENTION

The present invention is made in view of the above matters, and it is an object of the present invention to provide a controller for a fuel pump, which is able to set an appropriate completion timing of a full discharge control in which a discharge rate of the fuel pump is made maximum at starting of engine.

According to the present invention, a controller for a fuel pump is applied to a fuel injection system for an internal combustion engine. The fuel injection system includes an accumulator accumulating a fuel at high pressure, a fuel pump supplying the fuel to the accumulator from a fuel tank, and a fuel pressure sensor detecting a fuel pressure in the accumulator. The controller includes: an estimation means for estimating a start-control duration time after the engine is started until a difference between an actual fuel pressure in the accumulator and the target fuel pressure becomes lower than a specified value in a case that the fuel pump discharges the fuel at a maximum rate; and a start-control means for controlling the fuel pump in such a manner as to discharge the fuel at the maximum rate during the estimated start-control duration time.

A fuel quantity necessary for increasing an actual fuel pressure to a target fuel pressure is computed based on a difference between the actual fuel pressure and the target fuel pressure and a volume of a pipe between the fuel pump and the accumulator. A start-control duration time after the engine is started until the difference between the actual fuel pressure and the target fuel pressure becomes lower than a specified value can be estimated with high accuracy. During this start-control duration time, the fuel pump is controlled in such a manner as to discharge the fuel at a maximum rate. Thus, according to the present invention, a completion timing of a period in which the fuel pump discharges the fuel at the maximum rate can be appropriately established.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing an entire structure of a fuel injection system according to a first embodiment;

FIG. 2 is a block diagram showing a fuel pressure control in a delivery pipe according to the first embodiment;

FIG. 3 is a flow chart showing a procedure of a start-control according to the first embodiment;

FIGS. 4A to 4C are time charts showing a start-control according to the first embodiment;

FIGS. 5A to 5F are time charts showing a start-control according to a second embodiment;

FIGS. 6A to 6C are time charts showing a start-control according to a third embodiment; and

FIG. 7 is a block diagram showing a fuel pressure control in a delivery pipe according to a fourth embodiment.

### DETAILED DESCRIPTION OF EMBODIMENTS

### First Embodiment

Referring to drawings, a first embodiment of a controller for a fuel pump which is applied to a fuel injection system of a direct injection gasoline engine will be described hereinafter.

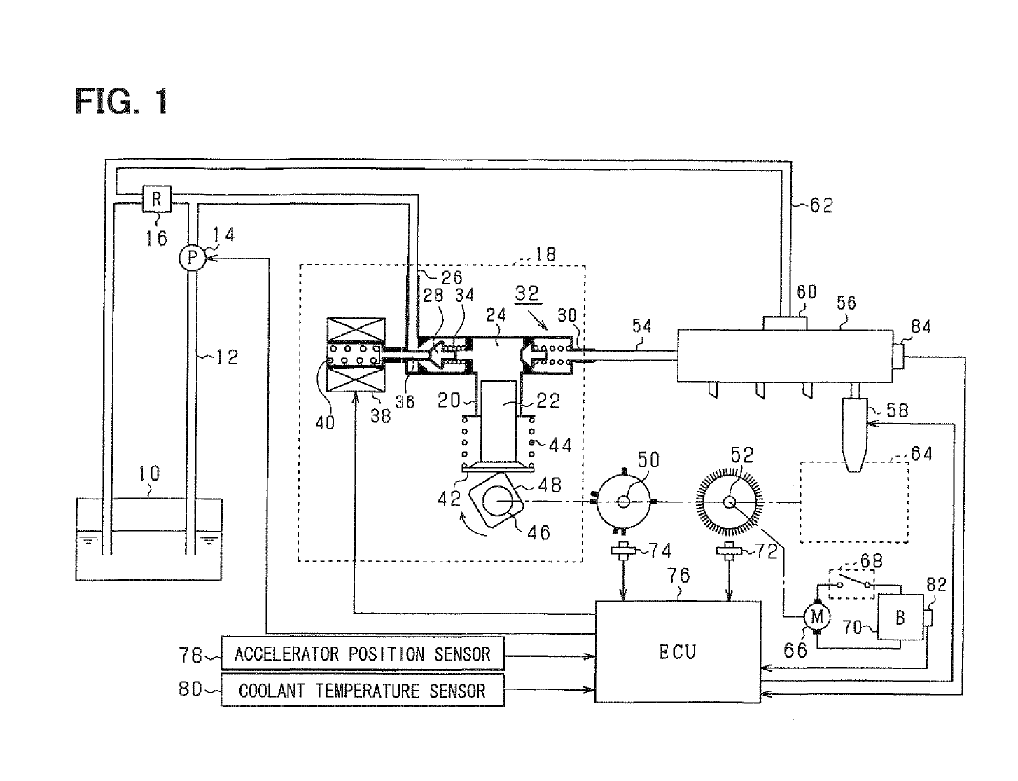

FIG. 1 shows an entire structure of a fuel injection system according to a first embodiment.

A fuel stored in a fuel tank 10 is pumped up by an electric feed pump 14 through a low-pressure pipe 12. The pumped-up fuel is adjusted to a low-pressure fuel by a low-pressure regulator 16 and is supplied to a high-pressure fuel pump 18.

The high-pressure fuel pump 18 has a cylinder 20, a plunger 22 reciprocating in the cylinder 20, a pump chamber 24 defined by an inner wall surface of the cylinder 20 and the plunger 22, a spill valve 28 connecting or disconnecting an inlet port 26 and the pump chamber 24, and a discharge valve 32 provided between an outlet port 30 and the pump chamber 24.

The spill valve 28 is biased to a close-position by a valve-closing spring 34. A valve-opening spring 40 biases the spill valve 28 in a valve-opening direction through a pushrod 36. When an electromagnetic solenoid 38 is energized, the pushrod 36 is attracted in a valve-closing direction of the spill valve 28. The biasing force of the valve-opening spring 40 is greater than the biasing force of the valve-closing spring 34. Thus, when the electromagnetic solenoid 38 is not energized, the spill valve 28 is opened by the biasing force of the valve-opening spring 40. When the electromagnetic solenoid 38 is energized, the pushrod 36 is magnetically attracted against the biasing force of the valve-opening spring 40. The biasing force of the valve-opening spring 40 is not transmitted to the spill valve 28 so that the spill valve 28 is closed by the biasing force of the valve-closing spring 34. The spill valve 28 is a normally opened valve.

The plunger 22 has a tappet 42 at its lower end. The tapped 42 is brought into a contact with a pump cam 48 by a spring 44. The pump cam 48 is driven by a driving shaft 46. The driving shaft 46 is mechanically connected to a camshaft 50. In FIG. 1, the camshaft 50 represents an intake camshaft and an exhaust camshaft. The camshaft 50 is driven by a crankshaft 52. A rotational speed ratio between the crankshaft 52 and the camshaft 50 is “1:2”. The driving shaft 46 rotates at half speed of the crankshaft 52. The pump cam 48 has a pump cam profile on its outer periphery. The plunger 22 reciprocates in the cylinder 20 in synchronization with the driving shaft 46. When the plunger 22 slides down, the volume of the pump chamber 24 is increased to suction the fuel into the pump chamber 24 (suction stroke). When the plunger 22 slides up, the volume of the pump chamber 24 is decreased to discharge the fuel from the pump chamber 24 (discharge stroke).

When the high-pressure fuel pump 18 is at the suction stroke, the spill valve 28 is opened to introduce the fuel into the pump chamber 24 through the inlet port 26. It is preferable that the electromagnetic solenoid 38 is deenergized to open the spill valve 28. However, even when the electromagnetic solenoid 38 is energized, the spill valve 28 can be opened. That is, the fuel pressure supplied from the feed pump 14 is applied to the spill valve 28 in the valve-opening direction, and a force generated due to an increase in the pump chamber volume is exerted on the spill valve 28 in the valve-opening direction. When these forces become greater than the biasing force of the valve-closing spring 34, the spill valve 28 can be opened.

Even when the high-pressure fuel pump 18 is at the discharge stroke, if the electromagnetic solenoid 38 is deenergized, the spill valve 28 is opened. Thus, even when the plunger 22 slides up in the cylinder 20, the fuel in the pump chamber 24 is returned to the inlet port 26 through the spill valve 28. Thus, the fuel in the pump chamber 24 is not pressurized, so that the high-pressure fuel pump 18 does not discharge the fuel. On the other hand, when the electromagnetic solenoid 38 is energized, the spill valve 28 is closed and the fuel in the pump chamber 24 is pressurized by the plunger 22. When the fuel pressure in the pump chamber 24 exceeds a valve-opening pressure of the discharge valve 32, the high-pressure fuel in the pump chamber 24 is discharged to the outlet port 30 through the discharge valve 32.

A discharge rate of the high-pressure fuel pump 18 can be adjusted by controlling a valve-closing timing of the spill valve 28 at the discharge stroke. Specifically, an early valve-closing timing of the spill valve 28 at the discharge stroke increases an effective stroke of the plunger 22 so that the discharge rate of the high-pressure fuel pump 18. In other words, as an energization start timing of the electromagnetic solenoid 38 is made earlier, the discharge rate of the high-pressure fuel pump 18 becomes larger.

The high-pressure fuel discharged from the high-pressure fuel pump 18 is introduced into a delivery pipe (accumulator) 56 through a high-pressure pipe 54. The delivery pipe 56 accumulates the high-pressure fuel therein and supplies the high-pressure fuel to a fuel injector 58 of each cylinder. It should be noted that the delivery pipe 56 is fluidly connected to the fuel tank 10 through a relief valve 60 and a relief pipe 62. The relief valve 60 is a pressure regulator which maintains the pressure in the delivery pipe 56 within a specified value.

The fuel injector 58 injects the fuel into a combustion chamber 64 directly. The injected fuel and an intake air are mixed and are ignited by a spark plug (not shown). A combustion energy is converted into a rotation energy of the crankshaft 52.

A starter 66 is connected to the crankshaft 52. When an ignition switch 68 is turned on, the starter 66 receives electricity from a battery 70 so as to crank the crankshaft 52.

A crank angle sensor 72 is arranged at a vicinity of the crankshaft 52 for detecting a rotational angle of the crankshaft 52. The crank angle sensor 72 outputs a rectangular crank angle signal when protrusions provided on a rotor of the crankshaft 52 pass the crank angle sensor 72. The protrusions are arranged at regular intervals (for example, 6° C.A). It should be noted that the rotor has no-protrusion portion for performing the cylinder identification. When this no-protrusion portion passes the crank angle sensor 72, the crank angle sensor 72 does not output the crank angle signal.

A cam angle sensor 74 is arranged at a vicinity of the camshaft 50 for detecting a rotational angle of the camshaft 52. The cam angle sensor 74 outputs a rectangular crank angle signal when protrusions provided on a rotor of the camshaft 50 pass the cam angle sensor 74. The protrusions are arranged at regular intervals (for example, 180° C.A). It should be noted that the rotor of the camshaft 50 has additional protrusions for performing the cylinder identification.

An electronic control unit (ECU) 76 controls various actuators for performing a fuel injection control. The ECU 76 receives detection signals from an accelerator position sensor 78, a coolant temperature sensor 80, a battery voltage sensor 82, a fuel pressure sensor 84 detecting the fuel pressure in the delivery pipe 56, the crank angle sensor 72, and the cam angle sensor 74. The ECU 76 controls an energization of the electromagnetic solenoid 38 so that the actual fuel pressure in the delivery pipe 56 agrees with the target fuel pressure.

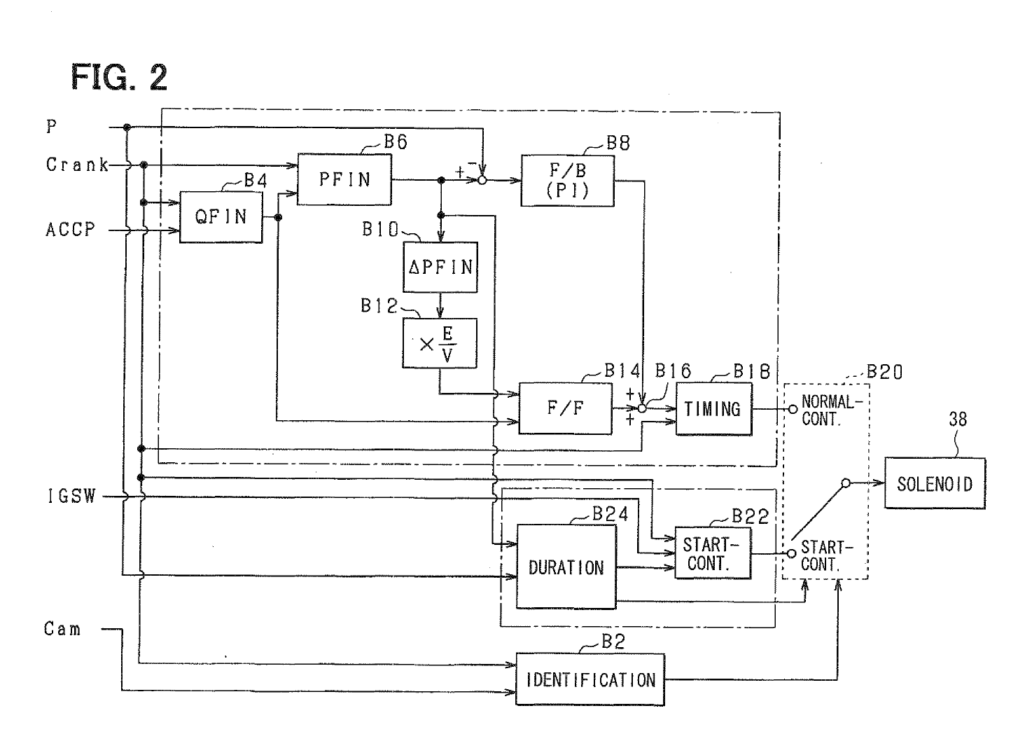

FIG. 2 is a block diagram showing a fuel pressure control in a delivery pipe 56.

A cylinder identification unit B2 performs a cylinder identification based on a crank angle signal “Crank” detected by the crank angle sensor 72 and a cam angle sensor “Cam” detected by the cam angle sensor 74. In the cylinder identification, the ECU 76 obtains a current rotational angle of the crank shaft 52 in one combustion cycle (720° C.A) in a case that the rotational angle of the crankshaft 52 is set as a reference (0° C.A) at a time when a specified piston is at a top dead center of a compression stroke. Further, the ECU 76 obtains a current position of the plunger 22. That is, the ECU 76 determines whether the high-pressure fuel pump 18 is at the suction stroke or the discharge stroke.

An injection quantity computation unit B4 computes a command fuel injection quantity “QFIN” based on an engine speed represented by the crank angle signal “Crank” and an accelerator stepped amount “ACCP” detected by the accelerator position sensor 78.

A target fuel pressure computation unit B6 computes a target fuel pressure “PFIN” in the delivery pipe 56 based on the command fuel injection quantity “QFIN” and the engine speed.

A feedback control unit B8 computes a discharge rate of the high-pressure fuel pump 18 (feedback amount), which is necessary for performing a feedback control in order that the actual fuel pressure “P” detected by the fuel pressure sensor 84 agrees with the target fuel pressure “PFIN” Specifically, the feedback amount is computed by proportional-integral control based on the actual fuel pressure “P” and the target fuel pressure “PFIN”.

A variation computation unit B10 computes a pressure variation “ΔPFIN” in the target fuel pressure “PFIN”. A convert unit B12 converts the pressure variation “ΔPFIN” into a fuel quantity which is necessary for varying the actual fuel pressure “P” by the pressure variation “ΔPFIN”. In this convert, a coefficient of volumetric expansion “E” of the fuel is divided by a total volume “V” of the high-pressure pipe 54 and the delivery pipe 56. The pressure variation “ΔPFIN” is multiplied by “E/V”.

A feedforward control unit B14 computes a discharge rate of the high-pressure fuel pump 18 (feedforward amount) which corresponds to a total quantity of the command fuel injection quantity “QFIN” and the fuel quantity obtained in the convert unit B12.

An addition unit B16 computes a final required discharge rate of the high-pressure fuel pump 18 by adding together the feedback amount and the feedforward amount.

A timing computation unit B18 computes an energization timing of the electromagnetic solenoid 38, which corresponds to a valve-closing timing of the spill valve 28, based on the crank angle signal “Crank” and the above final required discharge rate. Specifically, the energization timing of the electromagnetic solenoid 38 is derived from an energization timing map which is previously obtained by experiment by use of the final required discharge rate as a parameter. The electromagnetic solenoid 38 is energized during a specified time period from the energization timing when the high-pressure fuel pump 18 is at the discharge stroke.

A switch unit B20 switches an energization way of the electromagnetic solenoid 38 based on a determination result of the cylinder identification unit B2. That is, when it is determined that the cylinder identification has been completed, it can be determined whether the high-pressure fuel pump 18 is at the suction stroke or the discharge stroke. Thus, the electromagnetic solenoid 38 is energized at the energization timing computed by the timing computation unit B18. This energization of the electromagnetic solenoid 38 is referred to as a normal-control, hereinafter. The switch unit B20 electrically connects the timing computation unit B18 with the electromagnetic solenoid 38.

On the other hands, when it is determined that the cylinder identification has not been completed, it can not be determined whether the high-pressure fuel pump 18 is at the suction stroke or the discharge stroke. Thus, above described normal-control can not be performed. The switch unit B20 electrically connects a start-control unit B22 with the electromagnetic solenoid 38.

The start-control unit B22 starts to energize the electromagnetic solenoid 38 continuously in order that the discharge rate of the high-pressure fuel pump 18 becomes maximum when the ignition switch 68 is turned on. This processing is for restricting a deterioration in the exhaust characteristic after the engine is started. That is, in a case that the engine has been stopped for a long time period after the ignition switch 68 is turned off, it is likely that the actual fuel pressure in the delivery pipe 56 excessively decreases when the engine is re-started. For example, the fuel pressure in the delivery pipe 56 decreases to atmospheric pressure. The combustion condition after re-starting engine is deteriorated and the exhaust characteristic may be deteriorated. Thus, it is required that the actual fuel pressure is increased to the target fuel pressure immediately after the engine is re-started. However, until the cylinder identification is completed, the normal-control can not be performed. According to the present embodiment, the electromagnetic solenoid 38 is continuously energized after the ignition switch 68 is turned on until the cylinder identification is completed, whereby the discharge rate of the high-pressure fuel pump 18 is made maximum. This energization of the electromagnetic solenoid 38 is referred to as a start-control, hereinafter. In this situation, a stroke of the high-pressure fuel pump 18 is changed from the suction stroke to the discharge stroke while the electromagnetic solenoid 38 is energized, so that the spill valve 28 is closed from a start timing of the discharge stroke and the discharge rate of the high-pressure fuel pump 18 can be made maximum. Thus, the increase in the actual fuel pressure after the re-start of engine is expedited to restrict the deterioration in the exhaust characteristic.

If the actual fuel pressure is excessively low or excessively high at engine starting, the actual fuel pressure largely deviates from the target fuel pressure at a completion timing of the cylinder identification. When the start-control is terminated at the completion timing of the cylinder identification and the actual fuel pressure is excessively lower than the target fuel pressure, the integral term of the feedback control becomes excessively large, which may cause an overshoot. Also, when the actual fuel pressure is excessively higher than the target fuel pressure, an actual completion timing of the start-control is retarded relative to an appropriate completion timing. If the actual fuel pressure is excessively higher than the target fuel pressure at the actual completion timing of the start-control, the integral term of the feedback control becomes excessively large, which may cause an undershoot. As described above, if the start-control is terminated at the completion timing of the cylinder identification, it is likely that a controllability of the actual fuel pressure may deteriorate.

According to the present embodiment, a duration time computation unit B24 estimates a duration time (start-control duration time) until a difference between the actual fuel pressure and the target fuel pressure becomes lower than a specified value. During this start-control duration time, the start-control is performed to avoid the deterioration in controllability of the actual fuel pressure.

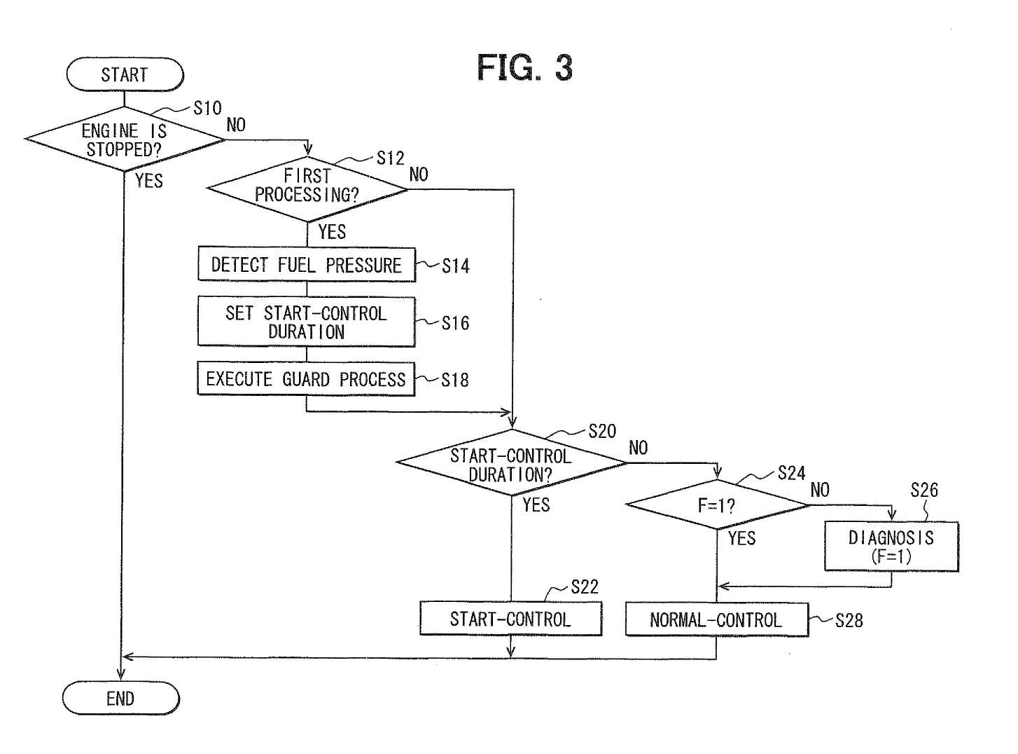

FIG. 3 is a flowchart showing a processing of the start-control. This process is repeatedly performed at a specified interval (5 msec) by the ECU 76.

In step S10, the computer determines whether the engine is stopped. This process is for determining whether it is a condition where the high-pressure fuel pump 18 is driven by turning on the ignition switch 68. It should be noted that the computer determines whether the engine is stopped based on the crank angle signal “Crank” and the cam angle signal “Cam”.

When the answer is NO in step S10, that is, when the engine is not stopped, the procedure proceeds to step S12 in which the computer determines whether the current processing is a first processing after the starter 66 is firstly driven by turning on the ignition switch 68. This process is for determining whether an engine start requirement is generated.

When the answer is YES in step S12, the procedure proceeds to step S14 in which the actual fuel pressure at engine starting is detected by the fuel pressure sensor 84.

In step S16, the computer sets a start-control duration time. It should be noted that the start-control duration time is quantified based on the number of output of the crank angle signal from the crank angle sensor 72 after the starter 66 is started. That is, the number of output of the crank angle signal until the actual fuel pressure “P” is increased to the target fuel pressure “PFIN” is defined as the start-control duration time. The discharge stroke of the high-pressure fuel pump 18 corresponds to the rotational angle of the crank shaft 52. The number of discharge of the high-pressure fuel pump fuel 18 which is required to increase the actual fuel pressure “P” to the target fuel pressure “PFIN” can be converted into the number of output of the crank angle signal. It should be noted that the maximum discharge rate of the high-pressure fuel pump 18 per one discharge stroke and an increment in the actual fuel pressure by one maximum discharge rate of the high-pressure fuel pump 18 depend on specifications of the high-pressure fuel pump 18, the delivery pipe 56 and the like. Thus, based on these specifications, the number of discharge (discharge stroke) of the high-pressure fuel pump 18 necessary for increasing the actual fuel pressure “P” to the target fuel pressure “PFIN” can be computed. Specifically, the total volume “V” of the high-pressure pipe 54 and the delivery pipe 56 is divided by the coefficient of volumetric expansion “E” of the fuel. The maximum discharge rate of the high-pressure fuel pump 18 is multiplied by “V/E” to obtain an increase in the actual fuel pressure due to one fuel discharge of the high-pressure fuel pump 18 at the maximum discharge rate. Then, the difference pressure between the fuel pressure at engine starting and the target fuel pressure “PFIN” is divided by the above increase in the actual fuel pressure to obtain the number of discharge of the high-pressure fuel pump 18.

In step S18, a guard process of the start-control duration time is executed. In this guard process, an upper guard and a lower guard are set to the start-control duration time. The upper guard is set in order to avoid a situation in which the reliability of the fuel pump 18 deteriorates due to a heat generation in the electromagnetic solenoid 38 when the energization of the electromagnetic solenoid 38 has been continuously energized for a long period. Also, the lower guard is set to ensure one discharge stroke of the high-pressure fuel pump 18 at the maximum discharge rate even if the difference between the actual fuel pressure at engine starting and the target fuel pressure “PFIN” is excessively small and a fuel quantity necessary for increasing the actual fuel pressure “P” to the target fuel pressure “PFIN” is excessively small. These upper and lower guards are set for performing an abnormality diagnosis which will be described later.

After the process in step S18 is completed, or when the answer is NO in step S12, the procedure proceeds to step S20 in which the computer determines whether current process is executing within the start-control duration time. This determination is executed based on whether the number of output of the crank angle signal “Crank” after the starter 66 is started until the current process is executed is equal to the number of output of the crank angle signal obtained in step S16.

When the answer is YES in step S20, the procedure proceeds to step S22 in which the switch unit B20 electrically connects the start-control unit B22 with the electromagnetic solenoid 38.

When the answer is NO in step S20, the procedure proceeds to step S24 in which the computer determines whether a diagnosis completion flag “F” is set to “1”. This process is for determining whether a diagnosis of a fuel system has been performed. When the diagnosis completion flag “F” is “0”, it means that the diagnosis has not been performed. When the diagnosis completion flag “F” is “1”, it means that the diagnosis has been performed.

When the answer is NO in step S24, the procedure proceeds to step S26 in which the diagnosis is performed. In this diagnosis process, it is diagnosed whether a defect exists in the fuel supply pipe between the fuel tank 10 and the fuel injector 58, the fuel injector 58 and the fuel pressure sensor 84. According to the present embodiment, the diagnosis is performed based on whether the variation in the actual fuel pressure “P” during the start-control duration time is within a specified range. If a fuel leakage occurs in the low-pressure pipe 12, the feed pump 14, the high-pressure fuel pump 18, the high-pressure pipe 54, the fuel injector 58 and the like, or if the fuel pressure sensor 84 has a malfunction, the variation in the actual fuel pressure “P” deviates from the specified range. When the diagnosis has been performed, the diagnosis completion flag “F” is set to “1”. If it is diagnosed that a defect exists, an engine check lump (not shown) is lighted to notify a driver of a defect.

When the process in step S26 is completed, or when the answer is YES in step S24, the procedure proceeds to step S28 in which the switch unit B20 electrically connects the timing computation unit B18 with the electromagnetic solenoid 38.

When the answer is YES in step S10, or when the processes in steps S22, S28 are completed, the processing is terminated.

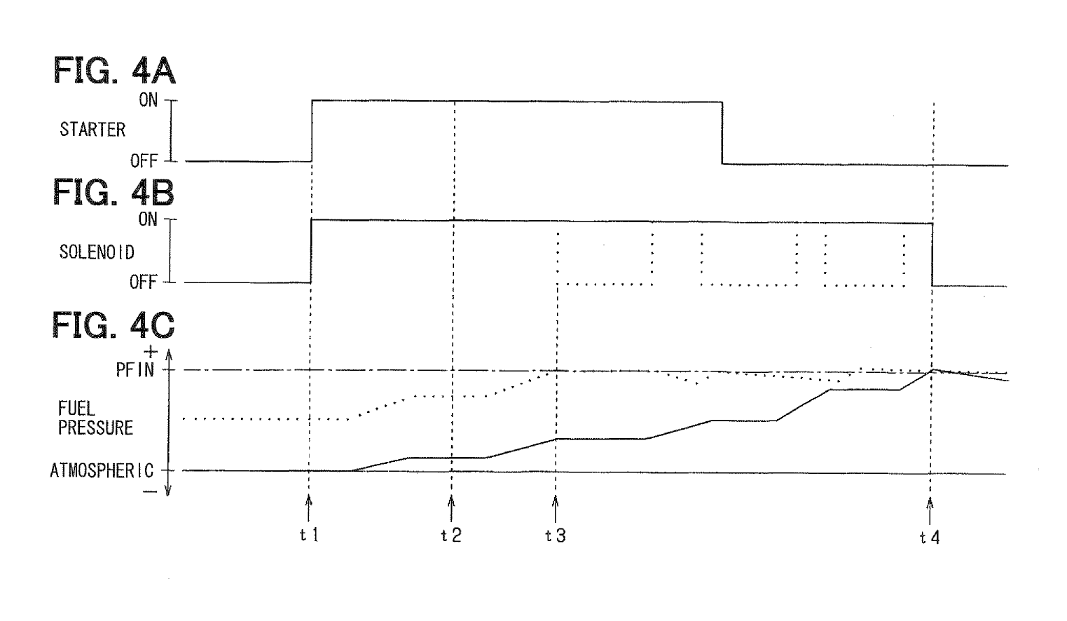

FIGS. 4A to 4C are time charts showing an energization operation of the electromagnetic solenoid 38 according to the start-control. Specifically, FIG. 4A shows ON-OFF condition of the starter 66, FIG. 4B shows ON-OFF condition of the electromagnetic solenoid 38, and FIG. 4C shows a variation in the actual fuel pressure “P”.

When the ignition switch 68 is tuned on and the starter 66 is started at a time “t1”, the start-control is started and is continued until the number of the output of the crank angle signal “Crank” reaches a specified number necessary for increasing the actual fuel pressure “P” to the target fuel pressure “PFIN”. That is, the electromagnetic solenoid 38 is continuously energized. In FIGS. 4B and 4C, solid lines represent ON-OFF condition of the electromagnetic solenoid 38 and the variation in the actual fuel pressure “P” in a case that the fuel pressure at engine starting is decreased to atmospheric pressure. Dotted lines represent those in a case that the fuel pressure at engine starting is relatively high. In a case that the fuel pressure at engine starting is decreased to atmospheric pressure, the start-control is performed during a period from a time “t1” to a time 14″. In a case that the fuel pressure at engine starting is relatively high, the start-control is performed during a period from a time “t1” to a time “t3”. Thus, the completion timing of the start-control can be set to an appropriate timing so that a difference between the actual fuel pressure “P” and the target fuel pressure “PFIN” is made as small as possible.

According to the above mentioned embodiment, following advantages can be obtained.

(1) The start-control duration time is set at starting of the starter 66, and the start-control is performed during this start-control duration time. Thereby, the difference between the actual fuel pressure “P” and the target fuel pressure “PFIN” is made as small as possible, so that an increase in the integral term of the feedback control is restricted and a deterioration in the controllability of the actual fuel pressure can be avoided.

(2) The start-control duration time is quantified based on the number of output of the crank angle signal “Crank” from the crank angle sensor 72. Thus, the completion timing of the start-control can be accurately and easily obtained.

(3) The upper guard of the start-control duration time is established. Thus, it can be avoided that the reliability of the fuel pump 18 deteriorates due to a heat generation in the electromagnetic solenoid 38 when the energization of the electromagnetic solenoid 38 has been continuously energized for a long period.

(4) The lower guard of the start-control duration time is established. Thus, a diagnosis can be performed immediately after the engine is started.

### Second Embodiment

A second embodiment will be described hereinafter, focusing on a difference from the first embodiment.

According to the second embodiment, in the start-control duration time, an energization period of the electromagnetic solenoid 38 is made short based on the crank angle signal “Crank” and the cam angle signal “Cam”. When the high-pressure fuel pump 18 is at the discharge stroke, the spill valve 28 is closed to discharge the high-pressure fuel. Even if the electromagnetic solenoid 38 is deenergized after the fuel discharge is started, the pressure in the pump chamber 24 is high enough to maintain the spill valve 28 closed. The fuel discharge is continued. Thus, after the spill valve 28 is closed by energizing the electromagnetic solenoid 38 at a start timing of the discharge stroke, the discharge rate of the high-pressure fuel pump 18 can be made maximum without respect to the energization of the electromagnetic solenoid 38.

Specifically, according to the present embodiment, a protrusion is provided on the rotor of the cam shaft 50 at an advanced position relative to the discharge stroke. The electromagnetic solenoid 38 is energized during a specified angle range including a start point of the discharge stroke after the protrusion is detected by the cam angle sensor 74. Thus, it can be avoided that the electromagnetic solenoid 38 is continuously energized before a stroke identification.

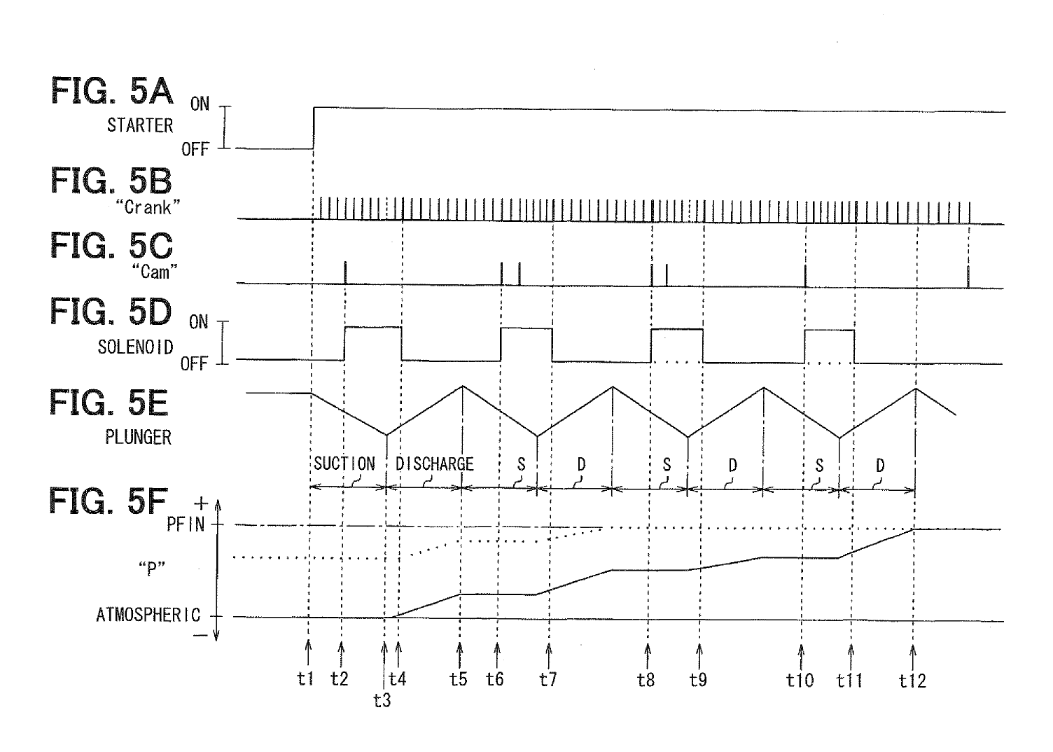

FIGS. 5A to 5F are time charts showing an energization operation of the electromagnetic solenoid 38 according to the start-control. Specifically, FIG. 5A shows ON-OFF condition of the starter 66, FIG. 5B shows a crank angle signal “Crank”, FIG. 5C shows a cam angle signal “Cam”, FIG. 5D shows ON-OFF condition of the electromagnetic solenoid 38, FIG. 5E shows a position of a plunger 22, and FIG. 5F shows a variation in the actual fuel pressure “P”. The output interval of the crank angle signal “Crank” is 6° C.A. However, in FIG. 5B, the output interval is indicated as 12° C.A.

When the starter 66 is started at a time “t1”, the start-control duration time is set. The electromagnetic solenoid 38 is energized from a time “t2” until a time “t4”. At the time “t2”, the cam angle signal “Cam” is outputted. The time “t4” corresponds to an end time of the specified angle range. Thereby, the stroke of the high-pressure fuel pump 18 is changed from the suction stroke to the discharge stroke, and the spill valve 28 is closed at a time “t3”. The high-pressure fuel pump 18 continues to discharge fuel from the time “t3” until a time “t5”. Similarly, the electromagnetic solenoid 38 is energized from a time “t6” until a time “t7”, from a time “t8” until a time “t9”, and from a time “t10” until a time “t11” so that the discharge rate of the high-pressure fuel pump 18 can be made maximum during the start-control duration time.

In FIGS. 5D and 5F, solid lines represent ON-OFF condition of the electromagnetic solenoid 38 and the variation in the actual fuel pressure “P” in a case that the fuel pressure at engine starting is decreased to atmospheric pressure. Dotted lines represent those in a case that the fuel pressure at engine starting is relatively high.

As described above, according to the present embodiment, the energization period of the electromagnetic solenoid 38 in the start-control duration time can be made short, and the electric power consumption of the electromagnetic solenoid 38 can be reduced. Further, it can be avoided that the reliability of the fuel pump 18 deteriorates due to a heat generation in the electromagnetic solenoid 38.

### Third Embodiment

A third embodiment will be described hereinafter, focusing on a difference from the first embodiment.

In the third embodiment, the spill valve 28 of the high-pressure fuel pump 18 is a normally close valve. That is, when the electromagnetic solenoid 38 is not energized, the spill valve 28 is closed. When the electromagnetic solenoid 38 is energized, the spill valve 28 is opened. By controlling a close timing of the spill valve 28 at the discharge stroke of the high-pressure pump 18, the discharge rate of the high-pressure fuel pump 18 is adjusted.

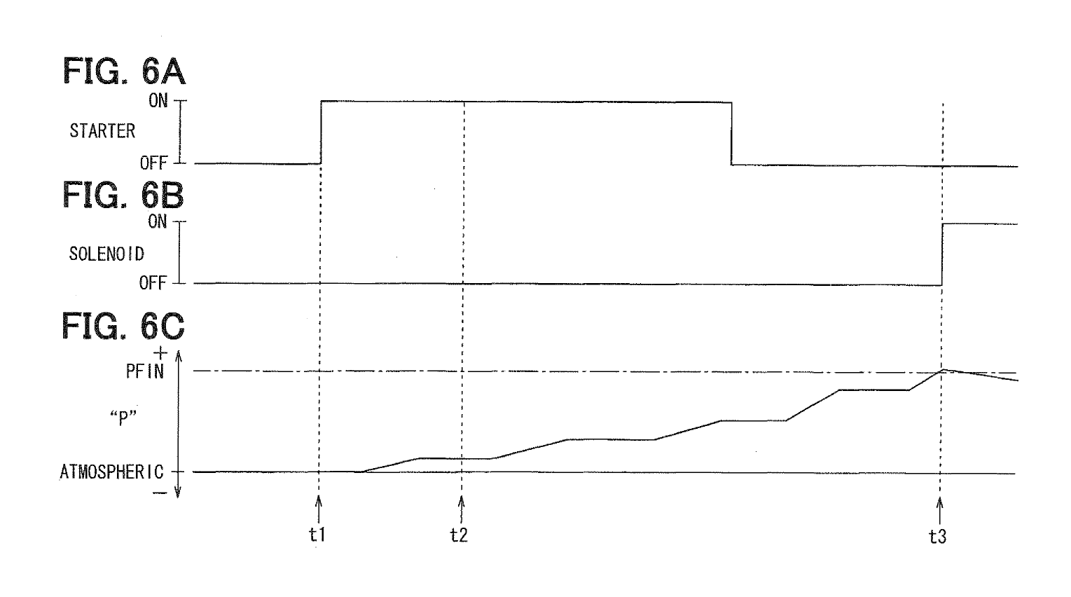

FIGS. 6A to 6C are time charts showing an energization operation of the electromagnetic solenoid 38 according to the start-control, and correspond to FIGS. 4A to 4C. FIG. 6C shows a case in which the fuel pressure at engine starting is decreased to atmospheric pressure.

The starter 66 is started at a time “t1”. During the start-control duration time from the time “t1” until a time “t3”, the electromagnetic solenoid 38 is continuously deenergized, so that the discharge rate of the high-pressure fuel pump 18 is made maximum. After the start-control duration time has passed, the normal-control is performed.

### Fourth Embodiment

A fourth embodiment will be described hereinafter, focusing on a difference from the first embodiment.

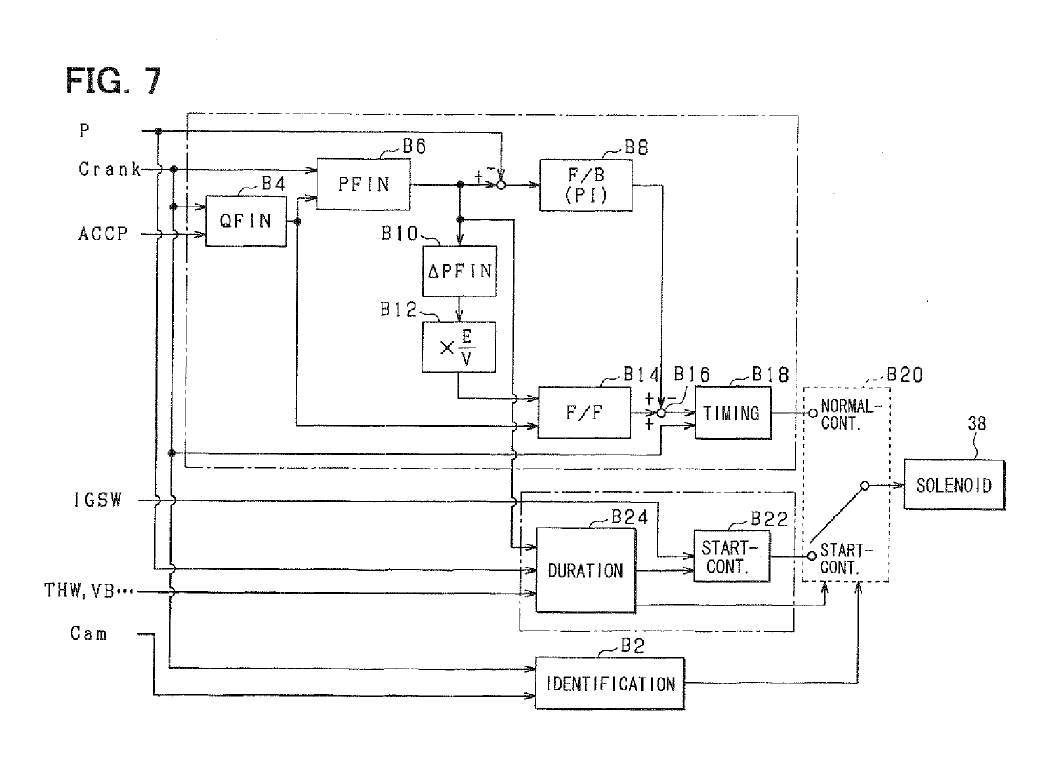

FIG. 7 is a block diagram showing a fuel pressure control in a delivery pipe 56. In the present embodiment, the start-control duration time is established based on a fuel quantity (number of discharge stroke of the high-pressure fuel pump 18) necessary for increasing the actual fuel pressure “P” to the target fuel pressure “PFIN”. It should be noted that the duration time computation unit B24 computes the start-control duration time based on a battery voltage “VB” detected by a battery sensor 82 and a coolant temperature “THW” detected by a coolant temperature sensor 80 in addition to the fuel pressure at engine starting and the target fuel pressure “PFIN”. If the battery voltage “VB” is low, the rotational speed of the starter 66 is decreased and a cranking speed is also decreased. Also, if the coolant temperature “THW” is low, a viscosity of lubricant is increased and the cranking speed is decreased. In these cases, the discharge rate of the high-pressure fuel pump 18 may vary and the difference between the actual fuel pressure “P” and the target fuel pressure “PFIN” may be increased when the start-control duration time has passed. According to the present embodiment, since the start-control duration time is established based on the battery voltage “VB” and the coolant temperature “THW”, the start-control duration time can be established with high accuracy.

It should be noted that the start-control duration time is computed based on the actual fuel pressure “P” and the target fuel pressure “PFIN”, and then the start-control duration time is corrected by the battery voltage “VB” and the coolant temperature “THW”. Alternatively, the start-control duration time can be derived from a four-dimensional map of the actual fuel pressure “P”, the target fuel pressure “PFIN”, the battery voltage “VB” and the coolant temperature “THW”.

### Other Embodiments

The above-mentioned embodiments may be modified as follows:
In the first embodiment, a processing interval of the ECU 76 is set to a specified period (5 msec). However, the processing interval of the ECU 76 can be set to an output interval of the cam angle signal “Cam”. When the engine speed is increased, the output interval of the cam angle signal “Cam” becomes short, which may increase a computation load of the ECU 76. For this reason, when the engine speed is lower than or equal to a specified value, the processing interval of the ECU 76 is set to the output interval of the cam angle signal “Cam”. When the engine speed is lower than the specified value, the processing interval of the ECU 76 is set to the specified period (5 msec).
In the above first embodiment, the start-control duration time is set based on the number of output of the crank angle signal “Crank”. Alternatively, the start-control duration time can be set based on the number of output of the cam angle signal “Cam”.
The fuel pressure at engine starting can be estimated based on the fuel pressure at engine stopping and an elapsed time from previous engine stopping until current engine starting.
The feedback control at normal-control may not include the integral term.
In the fourth embodiment, the start-control duration time is established based on parameters including the battery voltage “VB” and the coolant temperature “THW”. However, the start-control duration time can be established based on parameters including one of the battery voltage “VB” and the coolant temperature “THW”. The coolant temperature “THW” can be replaced by a fuel temperature.
In the above embodiments, when the engine is stopped, the plunger 22 of the high-pressure fuel pump 18 may be controlled to be positioned at a bottom dead center. Thus, when starting the starter 66, the position of the plunger 22 can be detected to obtain the discharge rate of the high-pressure fuel pump 18 with high accuracy. The accuracy of estimating the start-control duration time can be more improved.

The start-control duration time can be prolonged if the actual fuel pressure “P” does not reach the target fuel pressure “PFIN” at a specified timing. Further, the start-control duration time can be renewed at a specified timing.
In the above embodiments, the discharge rate of the high-pressure fuel pump can be established by feedback control.
In the second embodiment, the electromagnetic solenoid 38 can be continuously energized before the cam angle signal “Cam” is inputted or the stroke identification of the high-pressure fuel pump 18 is performed. This energization period of the electromagnetic solenoid 38 can include a start timing of the discharge stroke of the high-pressure fuel pump.
In the above embodiments, one cycle of the discharge stroke and the suction stroke is not limited to 180° C.A.

The present invention can be applied to a diesel engine as well as a gasoline engine.

What is claimed is:

1. A controller for a fuel pump applied to a fuel injection system for an internal combustion engine, which includes an accumulator accumulating a fuel at high pressure, a fuel pump supplying the fuel to the accumulator from a fuel tank and a fuel pressure sensor detecting a fuel pressure in the accumulator, the controller comprising:
an estimation means for estimating a start-control duration time at an engine starting time, the start-control duration time corresponding a duration after the engine is started until a difference between an actual fuel pressure in the accumulator and a target fuel pressure becomes lower than a specified value in a case that the fuel pump discharges the fuel at a maximum rate; and
a start-control means for controlling the fuel pump in such a manner as to discharge the fuel at the maximum rate during the estimated start-control duration time.

2. A controller for a fuel pump according to claim 1, wherein
the fuel pump suctions and discharges the fuel in accordance with a rotation of a crankshaft of the engine, and
the estimation means estimates the start-control duration time based on a number of discharge of the fuel pump at the maximum rate after an engine start requirement is generated until the difference between an actual fuel pressure in the accumulator and the target fuel pressure becomes lower than the specified value.

3. A controller for a fuel pump according to claim 1, wherein
the fuel injection system includes a cam angle sensor detecting a rotational angle of a camshaft of the engine and a crank angle sensor detecting a rotational angle of a crankshaft of the engine,
the fuel pump suctions and discharges the fuel in accordance with a rotation of the crankshaft or the crankshaft, and
the start-control means determines that the estimated start-control duration time terminates when a number of output of the cam angle sensor or the crank angle sensor reaches a specified value determined by the estimation means after an engine start requirement is generated.

4. A controller for a fuel pump according to claim 1, further comprising:
a detecting means for detecting at least one of a battery voltage and the coolant temperature, wherein
the fuel pump is driven by a driving force transmitted from a crankshaft of the engine, and suctions and discharges the fuel in accordance with a rotation of the crankshaft, and
the estimation means estimates the start-control duration time in consideration of a detection value of the detection means.

5. A controller for a fuel pump according to claim 1, wherein
the fuel pump suctions and discharges the fuel in accordance with a rotation of a camshaft or crankshaft of the engine, the fuel pump is provided with a normally open valve which fluidly connects or disconnects a fuel inlet port and a pump chamber in which the fuel is pressurized, the fuel pump of which discharge rate is adjusted according to an energization timing of the normally open valve, and
the start-control means energizes the normally open valve during the estimated start-control duration time.

6. A controller for a fuel pump according to claim 1, wherein
the fuel injection system includes a cam angle sensor detecting a rotational angle of a camshaft of the engine and a crank angle sensor detecting a rotational angle of a crankshaft of the engine,
the fuel pump suctions and discharges the fuel in accordance with a rotation of a camshaft and crankshaft of the engine, the fuel pump is provided with a normally open valve which fluidly connects or disconnects a fuel inlet port and a pump chamber in which the fuel is pressurized, the fuel pump of which discharge rate is adjusted according to an energization timing of the normally open valve, and
the start-control means energizes the normally open valve based on at least one of the cam angle sensor and the crank angle sensor during a time period which includes a start timing of a discharge stroke of the fuel pump and which is shorter than one cycle of a suction stroke and discharge stroke of the fuel pump.

7. A controller for a fuel pump according to claim 1, wherein
the fuel pump is provided with a normally close valve which fluidly connects or disconnects a fuel inlet port and a pump chamber in which the fuel is pressurized, the fuel pump of which discharge rate is adjusted according to an energization timing of the normally open valve, and
the start-control means deenergizes the normally close valve during the estimated start-control duration time.

8. A controller for a fuel pump according to claim 5, wherein
the estimation means sets an upper limit of a continuous energization period of the normally open valve.

9. A controller for a fuel pump according to claim 1, wherein
the estimation means estimates the start-control duration time during which at least one discharge of the fuel pump is conducted.

10. A controller for a fuel pump according to claim 9, wherein
the fuel injection system further includes: a fuel injector injecting a fuel supplied from the accumulator; and
a diagnosis means for performing a diagnosis whether a defect exists in a fuel supply pipe between the fuel tank and the fuel injector, the fuel injector, or the fuel pressure sensor.

11. A controller for a fuel pump according to claim 1, wherein
the fuel pump is provided with a valve which fluidly connects or disconnects a fuel inlet port and a pump chamber in which the fuel is pressurized,
the fuel pump of which discharge rate is adjusted according to an energization timing of the valve, further comprising:
an identification means for identifying whether the fuel pump is at a suction stroke or a discharge stroke; and
a control switching means for controlling an energization timing of the valve in such a manner that that the fuel pressure detected by the fuel pressure sensor agrees with the target fuel pressure after the identification means has identified whether the fuel pump is at a suction stroke or a discharge stroke.

12. A controller for a fuel pump according to claim 11, wherein
the control switching means controls an energization timing of the valve based an integral value of a difference between the fuel pressure detected by the fuel pressure sensor and the target fuel pressure.

13. A controller for a fuel pump applied to a fuel injection system for an internal combustion engine, which includes an accumulator accumulating a fuel at high pressure, and a fuel pump supplying the fuel to the accumulator from a fuel tank, the controller comprising:
an estimation means for estimating a start-control duration time at an engine starting time, the start-control duration time corresponding a duration after the engine is started until a difference between an actual fuel pressure in the accumulator and the target fuel pressure becomes lower than a specified value in a case that the fuel pump discharges the fuel at a maximum rate; and
a start-control means for controlling the fuel pump in such a manner as to discharge the fuel at the maximum rate during the estimated start-control duration time after an engine start requirement is generated.
